(19) United States
(12) Patent Application Publication
(10) Pub. No.: US 2011/0138356 A1
(43) Pub. Date: Jun. 9, 2011

(54) METHOD AND SOFTWARE PROGRAM PRODUCT FOR ON-THE-FLY MATCHING OF MESSAGES

(75) Inventors: Steinar Kristoffersen, Oslo (NO); Anders Moen Hagalisletto, Oslo (NO)

(73) Assignee: UNIVERSITY OF OSLO, Oslo (NO)

(21) Appl. No.: 13/001,766

(22) PCT Filed: Jun. 30, 2009
(86) PCT No.: PCT/EP2009/004700

§ 371 Date: Feb. 15, 2011

Related U.S. Application Data
(60) Provisional application No. 61/076,965, filed on Jun. 30, 2008.

(51) Int. Cl. G06F 9/44

(52) U.S. Cl. 717/123

(57) ABSTRACT

A method of matching message elements, including a reading step of reading a contents of a first message and a second message and a determining step that determines whether the content of the first message is the same as the content of the second message, wherein if the content of the first message matches the content of the second message, a new pair is formed that includes the content of the first message and the content of the second message. The method further includes a matching table lookup step of reading a matching table, which stores one or more pairs of matching elements, a consistency check step to determine whether the new pair is consistent with the one or more pairs of matching elements stored in the matching table, and a storage step for storing the new pair to the matching table based on the result of the consistency check step.

### TECHNICAL FIELD

The present invention relates generally to computer software, and more specifically to software used for on-the-fly matching of message contents.

### BACKGROUND

Message matching has many uses in the computer software. For example, message matching technology can be used in integrating disparate computer software components, or in analyzing data traffic through a network device. Other, less obvious uses for matching include grouping of users in an online community and developing ad-hoc tutorials for IT systems repair.

Integration of software applications is often both costly and cumbersome, even if the programs to be integrated are designed to be used in a similar way. In fact, project management and program support for software integration can consume roughly the same amount of resources as initial development. Integration strategies are useful to alleviate the burden somewhat, but they often reduce the functionality of the integrated software. Integration strategies also tend to reduce the flexibility of the integrated program, and may make future maintenance more difficult.

The current global systems integration market is valued at approximately $85 billion, which surpasses many estimates of the value of the application development market. Additionally, as many as 65% of integration projects require additional time and/or budget to complete. Many of the current integration solutions are based on the Component Object Model (COM) or the Distributed Component Object Model (DCOM) and Common Object Request Broker Architecture (CORBA), and have proven to be largely inflexible to changing requirements. More loosely-coupled solutions based on web services are able to handle document structures well, but do not facilitate object distribution.

The majority of software systems purchased in the current marketplace are commercially available off the shelf. Such programs typically are not designed to be easily integrated with other systems the consumer wishes to use. These programs are generally difficult, if not impossible to integrate.

Alternatively, the consumer could develop a system using “hard-wired” integration, where each component to be integrated exports data to a common public interface, which allows one component to invoke the functionality of any other component. These systems are efficiently integrated, but maintaining the system is often difficult, since changes made to one component may cause unintended incompatibilities to manifest in other components.

Another possibility is a wrapper implementation, in which wrappers make up a meta-data layer between components to be integrated. In this implementation, functions are developed to wrap components, allowing one component to invoke the functionality of another component without directly addressing the component. In this way, the functionality of the components is abstracted, while still retaining the functionality of an integrated system. This abstraction allows for easier maintenance of components. However, total cost of ownership when using a wrapper implementation is often greater because expanding functionality require new wrappers and/or additional components. Additionally, a large amount of architectural knowledge regarding each component is needed in order to implement each wrapper. Additionally, the functionality of each of the components is often under-exploited in an effort to maintain a stable interface.

An integration engine typically has a hub design, which collects all integration functionality into one runtime module, which unifies the interface of similar components to aid invoking agents. However, integration hubs typically require a server-based runtime infrastructure that may require use of awkward architecture, and may enforce alien policies for security, transactions, backup, or the like.

Because of the drawbacks of each of the systems described above, embodiments of the present invention relate to an event-based software integration method driven by an on-the-fly matching method that is characterized by interacting components that broadcast events pertaining to their integration needs. Event-based integration uses a loosely coupled design that can accommodate even situations where it is unknown which components the system should integrate towards. The proposed system is an ad-hoc, automatic event based integration system that can recover from incompatibilities, even if those incompatibilities were not explicitly known in advance.

With regard to grouping users of online communities, one of the biggest challenges for online community managers is breaking down a relatively large user base into smaller groups that have similar interests, particularly when there is no guarantee that users will select groups on their own. Additionally, users are often hesitant to join groups when they do not already know the existing group members. Thus, embodiments of the present invention relate to a matching method that is capable of dividing users into subgroups based on their actions within the group, thus creating subgroups of users who have similar interests, even when members of the subgroups did not know one another prior to joining the subgroups.

Finally, the matching algorithm has implications for software documentation and troubleshooting. Documenting common problems with IT systems, together with their solutions can be a difficult and time-consuming process, and users often complain that the documentation is not particular to their systems, or that the documentation does not include their particular problems. Accordingly, the matching algorithm can be used to generate an ad-hoc user manual for troubleshooting IT systems, obviating the need to spend significant amounts of time developing tutorials for clearing up problems with IT systems, while creating instructions that are particular to a user's specific systems.

### DISCLOSURE OF INVENTION

The present invention preferably includes a method of matching message elements, including a reading step of reading a contents of a first message and a second message and a determining step that determines whether the content of the first message is the same as the content of the second message, wherein if the content of the first message matches the content of the second message, a new pair is formed that includes the content of the first message and the content of the second message. The method further preferably includes a matching table lookup step of reading a matching table, which stores one or more pairs of matching elements, a consistency check step to determine whether the new pair is consistent with the one or more pairs of matching elements stored in the matching table, and a storage step for storing the new pair to the matching table based on the result of the consistency check step.

Another aspect of embodiments of the present invention includes a method of integrating two or more software components, including steps of modelling a first software component as a finite state machine having a plurality of states, and one or more transitions connecting the plurality of states, wherein each of the one or more transitions is associated with a message and modelling a second software component as a finite state machine having a plurality of states, and one or more transitions connecting the plurality of states, wherein each of the one or more transitions is associated with a message. The first software component sends the associated message each time a current state of the first component follows one of the transitions. The second software component receives the message sent by the first software component, and determines whether the received message matches an expected message. If the second component determines that the received message matches the expected message, the second component sends a response to the first component.

### BRIEF DESCRIPTION OF DRAWINGS

FIG. 1 is a representation of a matching module contained in a component of the present invention;

FIG. 2 is a block diagram showing the flow of a message from one component to a second component according to an embodiment of the invention;

FIG. 3 is a finite state diagram representing one application to be integrated according to the present invention;

FIG. 4 is a finite state diagram representing a second application to be integrated according to the present invention;

FIG. 5 is a partial application graph showing non-deterministic matching with distinct continuation;

FIG. 6 is a partial application graph showing non-deterministic matching with merged continuation;

FIG. 7 is a partial graph showing an application that requires backtracking; and

FIG. 8 is an application graph that shows the backtracking process.

### MODES FOR CARRYING OUT THE INVENTION

An embodiment of the matching method described herein is a computer program stored on a computer-readable medium, such as a hard disk, Random Access Memory (RAM), Read Only Memory (ROM) Flash memory, magnetic or magneto-optical disk, a CD-ROM, a DVD, or the like. The program is executed by a processor, causing the computer to execute an embodiment of the matching method.

It is necessary to define terms used throughout the specification. As used herein, a message contains at least a content C, a source x, and a destination y. Thus, messages are written in the form
msg C from x to y
   where C represents message content, x is an address of the source agent (i.e., the agent sending the message), and y is an address of the destination agent (i.e., the agent receiving the message).

The content C of a message is written in a matching language that is constructed from three basic element types: constants, variables, and wildcards. The matching language also includes the empty word. Additionally, the language supports concatenation of elements, so that if elements t₁ and t₂ are part of the matching language (i.e., the elements t₁ and t₂ are one of the three basic element types), then concatenated element t₁_{_{—}}t₂ is also a part of the matching language.

A constant is a message element that does not change during execution of the application; a variable is a message element that can change during execution of the application; and a wildcard is a special type of variable that is reset for each assignment. A matching pair is a pair <e₁, e₂>, where both e₁ and e₂ are basic elements. A matching table is a set of matching pairs T={<e₁, e₂>, . . . , <eᵢ, eⱼ>}, Similarly, an agent table is a pair <b, T>, where b is a name of an outside agent and T is a matching table associated with that agent.

A transition is a triple <n₁, n₂, 1>, where n₁ and n₂ are nodes and 1 is a label. A transition is said to be reflexive when n₁=n₂. A path from node n₁ to node nₖ is written n₁→nₖ, and describes a sequence of nodes <n₁, . . . , nₖ> such that for any two sequential nodes nᵢ, nᵢ₊₁ in the path, there exists a transition <nᵢ, nᵢ₊₁, 1> between the nodes.

A labelled graph is a pair <N, E> where N is a set of nodes and E is a set of transitions. A graph is said to be connected if, for every node nₓ and n_{y}, there is a path nₓ→n_{y}, or a path n_{y}→nₓ, or there exists a node n_{z} such that there are paths nₓ→n_{z} and n_{y}→n_{z}. A connected graph is cyclic if there are two distinct nodes nₓ and n_{y} such that there are paths nₓ→n_{y}, and n_{y}→nₓ.

An application graph is a four-tuple A=<I, N, E, U>, where I is the name of an application, N is a set of nodes, E is a set of transitions, and U is a designated current node, such that U is a member of the set of nodes N.

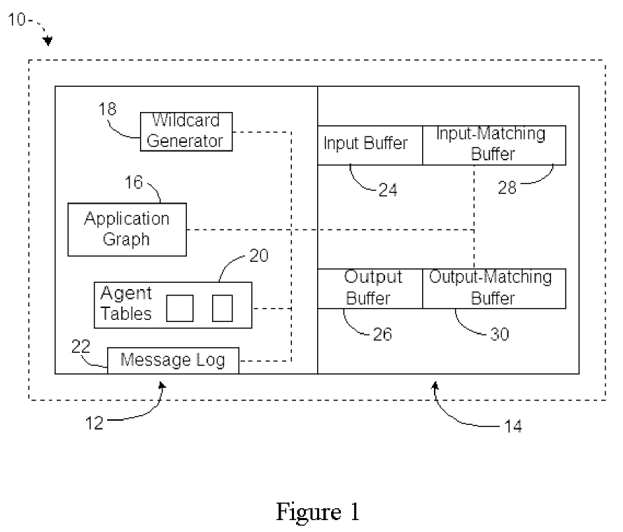

FIG. 1 shows a block diagram of an embodiment of the architecture of a matching module 10 used to match messages. The matching module 10 has two main parts, a matching component 12 and a communication component 14. The matching component 12 contains at least an application graph 16, a wildcard generator 18, and one or more agent tables 20. The matching component 12 also preferably includes a message log 22. The communication component 14 includes the input buffer 24, output buffer 26, input-matching buffer 28, and output-matching buffer 30.

The application graph 16 is an event-based finite state machine that describes high-level behaviour of the application. Each node of the application graph represents a possible state of the application, and the labels applied to transitions from one node to the next describe communications that are permitted when moving from one node to the next according to the transitions.

The wildcard generator 18 is a counter that provides fresh indexes to the wildcards.

The one or more agent tables 20 each contain the name of a foreign agent and a matching table associated with the foreign agent so that the host is able to interpret messages received from the foreign agent. Each agent table is created on demand, and the matching table included in each agent table is constructed during operation.

The message log 22 is a set of messages relevant to the application, ordered by processing time.

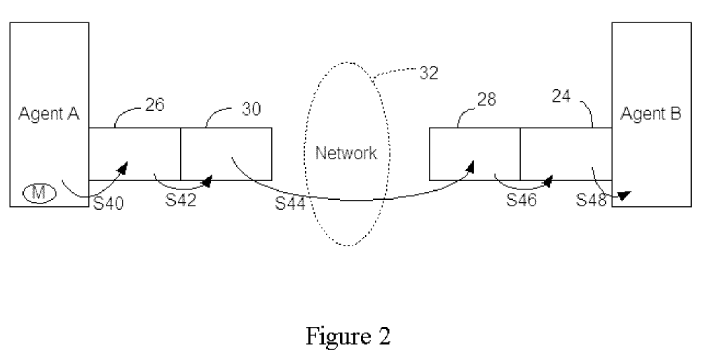

FIG. 2 shows a network facilitating communication between agent A and agent B, where both agents are running a matching module. For agent A to transmit a message M to agent B, in step S40 agent A places the message in the outgoing buffer 26. Elements from message M are then moved, in step S42, from the output buffer 26 to the output-matching buffer 30, and tagged with an operator matchmsg(M), indicating that message M is ready to be matched.

The message M in the output buffer 26 is then checked to ensure that it matches the components stored in the output-matching buffer 30, and compared with the application graph contained in agent A's matching module 10. If the message M matches both the elements in the output-matching buffer 30 and the application graph, the matchmsg(M) operator tag is removed, and the message M is transferred across a network 32 to an input buffer 24 for the matching module running on agent B in step S44. In this case, the network 32 may be a wide area network (e.g., the Internet), a local area network, a direct connection from one computer to another, a connection between components in a single computer, or the like. After the message M is received at the input buffer 24, it is transferred to the input-matching buffer 28 in step S46 and again tagged with the operator matchmsg(M). If the message M matches with the matching table and application graph maintained in the matching module 10 on agent B. the matchmsg(M) operator tag is removed, and the message is ready for processing by the receiving agent B in step S48.

During the matching process, the matching module 10 performs a Boolean test
match?(M, T, A)
   that determines whether a given message M matches an application graph A with respect to a matching table T.

When matching message content, two sequences of message contents C₁, C₂ are compared with respect to a matching table T and an application graph A. In performing the comparison, first all transitions starting at the current node U identified in the application graph A are collected into a set of potential matching candidates. Then, each of the collected transitions is matched with the current message using a Boolean function matchC?(C₁, C₂, T), where C₁ and C₂ are message contents, and T is a matching table. The function returns a Boolean value of TRUE when the input message contents are identical, or when the message contents <C1, C2> represent a matching pair that can consistently be added to the matching table. Additionally, concatenated message contents are compared element by element, from left to right.

The concept of determining which pairs can be consistently added to a matching table is crucial to accurately defining matching. Also, the concept of determining which pairs can consistently be added can be difficult to balance, since a too-strong matching policy will exclude pairs that could reasonably be added to the matching table, while a too-weak policy can result in invalid matches. For our purposes, a pair E=<e₁, e₂>, where e₁ represents an element from the message and e₂ represents an element from the graph, can be consistently added to a matching table if E already exists in the matching table; or if e₂ is a wildcard; or if e₂ is not a wildcard and has not been matched yet, and e₁ does not match a constant in the matching table. While this definition of consistent augmentation is preferred, it will be recognized by those skilled in the art that alternative definitions may be used without departing from the spirit of the invention.

Assuming matchC?( ) returns a value of TRUE (i.e., a message matches with the application graph and the current matching table), the matching can be executed. When matching is executed, the matching table is updated with new matching pairs, the application graph is adjusted to include names of other components, the indexes of wildcards are reset using the wildcard generator 30, and the message is translated into the host component's language, based on the agent table.

The execution of matching is denoted
M(C1, C2, <b, T>, A, W, t).
   Execution of matching matches two contents C1 (the message content) and C2 (the graph content) with respect to an agent table <b, T>, and application graph A, a wildcard generator W, and a transition t as input. The function returns a revised agent table, application graph, and wildcard generator.

The returned wildcard generator generates new wildcard values based on a previous wildcard value and a counter value. Additionally, the index of the wildcard value retains information regarding previous instantiations, such that given a wildcard Xᵢ having an index i and a wildcard generator index j, the new wildcard value is represented as X_{i∘j}, so that the history of the wildcard instantiations can be easily determined.

When executing a match, it is first determined whether the message contents are empty. If both message contents are empty, the matching is successful, the current pointer is moved to the next state, and the condition expresses that the active transition may send or receive events. If the message contents are non-empty, then there are three possible cases: if the initial elements of the two message contents are identical, then the matching process should continue; if the elements of the initial contents are different, and the second element (i.e., the element taken from the application graph) is not a wildcard, the pair is added to the table before continuing match processing; and if the initial element taken from the application graph is a wildcard, the wildcard is refreshed and the element taken from the message is matched with the refreshed wildcard.

One application of the framework described above is to synchronize multiple software components. For example, users could connect wirelessly to a server to play a game of blackjack. In this scenario, the server acts as the dealer, while the users act as players. Each of the players and the server can have different implementations of the application (i.e., different components), different commands, and potentially different high-level understandings of the game. For convenience, however, it is assumed that all components include the notions of cards and stock. Additionally, it is assumed that the dealer will deal cards in a truly concurrent manner, rather than in an order specified by table position.

Blackjack is a simple game, which involves betting between the player and the dealer about who will get a score of closest to 21 without going over by drawing cards from a deck comprising multiples of 52 standard playing cards. An ace scores either a 1 or 11, kings, queens and jacks count for 10 and all other cards maintain their numerical value.

The game starts by the player placing a bet, usually above some lower limit. The dealer first deals two cards to each player, then two cards to himself. All the players' cards are dealt face up. The bank's first card is face-down, the second is face-up. The players ask, in subsequent rounds to be “hit” (i.e., be dealt more cards, one at a time), or to “stand” (i.e., to complete their round), after which they wait until all other players and the dealer have finished. While the player decides when to “stand,” if the player exceeds the limit of 21 points, he is “bust” and his bet is immediately collected by the dealer.

The dealer plays when all players have either asked to “stand” or have “busted” and starts by showing his face-down card. The dealer usually plays according to house rules, which may, for example, stipulate that the dealer must continue drawing cards while his point total is 16 or less, and that he must stand as soon as he reaches 17 or more. All players who have scored higher than the dealer and no higher than 20 are paid double their bet, and any player having a total of 21 exactly receives twice that. If the dealer and a player score the same sum, the dealer wins and the player receives no return on his bet. While there are additional variations and advanced rules, the above will serve as the basis for an example of the use of the present invention.

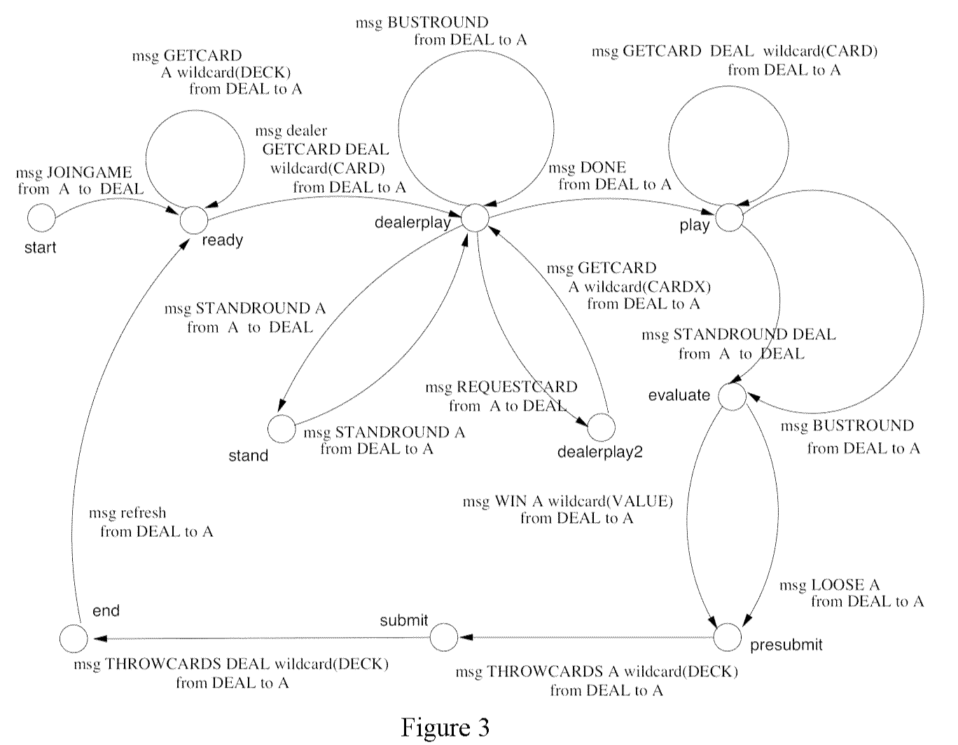

FIG. 3 shows a finite state machine representing a dealer's view of the blackjack game. From the dealer's initial state, the dealer waits to receive a message “joingame” from a client A. Once at least one player has sent the message “joingame” to the dealer, the dealer enters the ready state. From the ready state, the dealer sends a message “getcards” to each player, providing the players with two cards, and a message “dealergetcards” to the players to inform them that the dealer has received his two cards.

The dealer then waits for a message from the player. The player can send a message “stand” or a message “requestcard” to the dealer. In response, the dealer will either acknowledge the player's request to stand, or provide the player with a card, respectively. Additionally, the dealer checks the point totals for each player and sends a message “bust” to any player who has exceeded 21 points.

Once all players have finished their interactive portions, the dealer sends a message “done” to all players. The dealer then enters the play state, in which the dealer sends messages to the players. The dealer may send a message “dealergetcard” or “dealerstand.” Additionally, the dealer checks its point total and sends a message “dealerbust” if the dealer's total points exceed 21.

When the dealer sends a “dealerstand” or “dealerbust” message, the dealer transitions to an evaluation state. In this state, the dealer sends each player either a message “playerwin” or a message “playerlose.” Following that, the dealer sends a message “throwcards” to each player to release that player's cards, and a message “dealerthrowcards” to each player to release the dealer's cards. Finally, the dealer sends a message “refresh” to each player when transitioning back to the ready state.

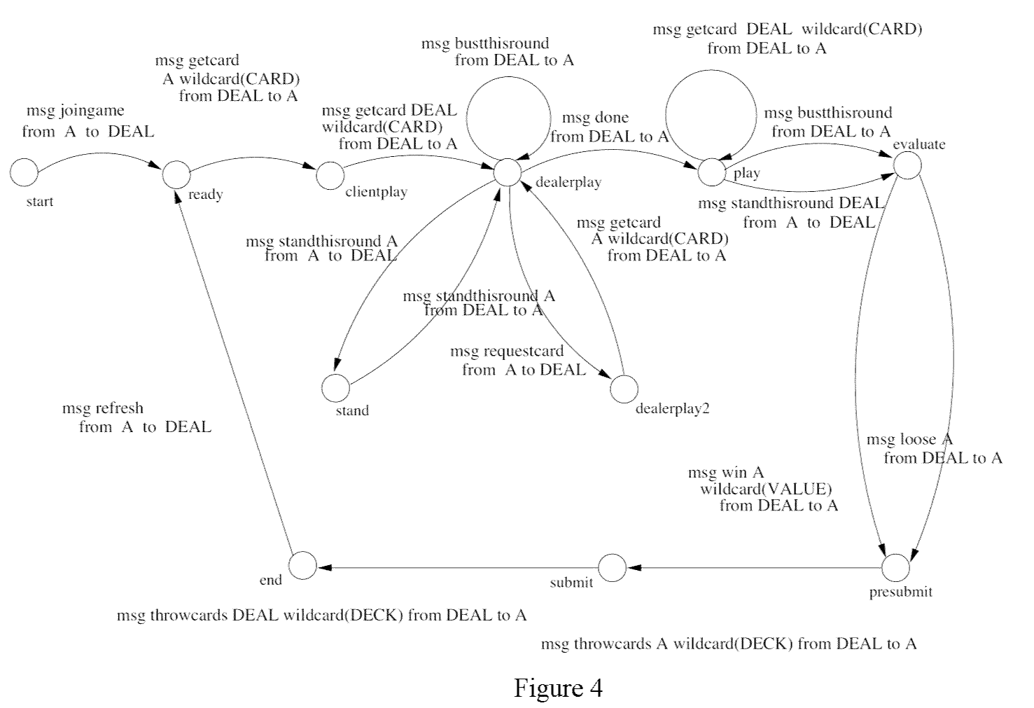

FIG. 4 shows a finite state machine of the player's view of the blackjack game. The structure of the application player's state machine is largely identical to that of the dealer. The main difference between the player state machine and the dealer state machine appears in the ready state. While the dealer ready state includes a reflexive transition to distribute cards, the player instead transitions to a state clientplay when he receives a message getcards from the dealer. This distinction reflects the difference between the roles of player and dealer: while the dealer may be called upon to distribute cards to multiple players each round, each player will receive a set of cards only once per round.

Each application may contain cycles of three distinct types: reflexive transitions, explicit cycles relying on the message refresh, and implicit cycles.

The main task of the refresh command is to signal that variables should be reset. Resetting variables involves utilizing a sequence of matching tables, rather than only a single matching table. While an obvious method of refreshing is to simply remove all data from the matching table, this method is not ideal because the re-learning of matching constants provides no benefit to the component. Additionally, if the constant matches for the current matching table Tₙ are lost, then the next table Tₙ₊₁ has an increased chance of introducing erroneous constant matches. Accordingly, the optimal solution is to retain all constant matches in table Tₙ, while removing any variable matches.

The blackjack specifications and state machines can be produced in software and stored on a computer-readable medium such as magnetic or optical disks, a random access memory (RAM), a read only memory (ROM), flash memory, or the like. The software is preferably written in a declarative specification language, such as Maude, but could be written using any of a number of alternative languages.

Alternatively, the matching method described above could be used to analyze and present data traffic passing through a network device, such as a network hub. Accordingly, the analysis of data traffic can be used to document and monitor trends in the traffic, and for maintaining the network in good repair. Moreover, while integration of software components is not necessarily a goal for this use of the on-the-fly matching method, integration projects may be a beneficiary of the method, since large enterprise integration architectures contain components that allow for interception of data traffic, and the evolutionary nature and complexity of software integration projects often calls for extensive documentation so that the projects can remain serviceable over a substantial period of time.

Accordingly, as an example, data traffic analysis and monitoring will be discussed as they relate to an enterprise integration architecture. An agent is placed within the integration architecture so that the agent can intercept, for example, traffic transferred through an integration bus. When traffic is intercepted, messages are translated into the standard format of “msg C from x to y,” as discussed above.

Once messages are put into a usable form, they are grouped into a naïve labelled transition system. The labelled transition system includes a set of anonymous states and a set of transitions, as described above.

After the transition system has been created, the matching algorithm is applied to the labelled transition system as described above, creating a more structured and compact application graph. When the matching method is used to analyze data traffic at a network hub, all pairs can be consistently added to a matching table. That is, all pairs are added to the matching table, so that statistics may be gathered about all of the intercepted messages.

Finally, the created application graph is exported to a visualization tool so that data may be reviewed in a clear and meaningful manner.

The matching method is also useful for grouping data. As an example, users of a social network may be organized into subgroups based their participation in the network. That is, messages from users can be analyzed to form subgroups, even when the individual users in a subgroup do not know one another.

Messages sent by each user are intercepted by an agent and converted to the format of “msg C from x to y,” as discussed above. Each user's messages are gathered to form a labelled transition system, which is then compacted using the matching method, as discussed previously. That is, pairs are added to the matching table only if the pair can be consistently added to the existing matching table. Accordingly, the system generates an application graph representing each user's activity within the social network.

To create the subgroups from the output application graphs, the mathematical concept of bisimilarity may be used. That is, users may be placed in the same subgroup when the application graphs associated with the users are bisimilar. Of course, those of skill in the art will understand that other criteria may be used to determine the method of organizing users into subgroups without departing from the spirit of the invention.

Yet another application of the matching method discussed above is in generating ad-hoc documentation for information technology systems. That is, the past successes of various users are compiled so that the current user is presented with appropriate actions to resolve a malfunction.

In this case, whenever a user performs a troubleshooting action, steps taken to resolve the user's problem are converted into standard messages as explained previously, and inserted into a labelled transition system. The labelled transition system is used to generate an application graph as discussed above, and a matching table is updated when pairs can consistently be added to the existing matching table. The application graph is stored in a database or other repository, and is made available to all subscribing users.

When a particular user encounters difficulty with a system, a user is presented with suggestions indicating actions that were previously successful in resolving the encountered difficulty. Simple pattern matching is generally sufficient to establish which actions carried out by users are appropriate suggestions, but bisimulation, set algebra, or the like may also be used without departing from the spirit of the invention. Thus, a dynamic user manual is co-constructed based on the collective experiences of all users of the system.

Because each component has a localized view and lacks global knowledge, mismatches of elements occur relatively frequently. Even using the strict matching algorithm discussed above, it is possible that a matching session could fail due to non-deterministic matching choices. For example, if a component receives message
M=(msg ex_ey from a to b)
   the receiver b might be in a state s where two matches are possible, such as
t1=<n1, n2, msg e1_e2 from a to b>
   and
t2=<n1, n3, msg e3 e4 from a to b>
   Hence the receiver b might extend the matching table with either
T1={<ex, e1>, <ey, e2>}
   based on transition t1 or the match
T2={<ex, e3>, <ey, e4>}
   based on t2.

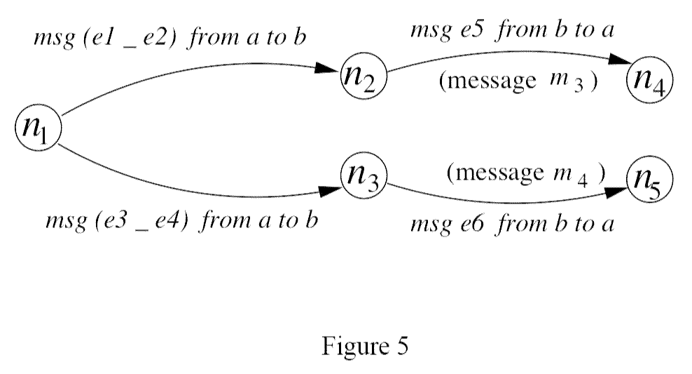

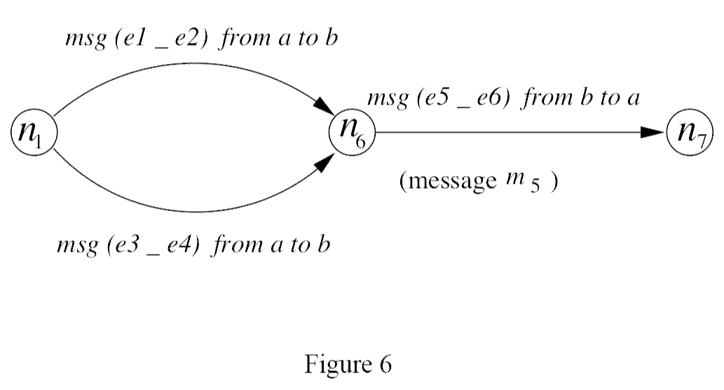

The application graph can be of two main types: branching as in FIG. 5 or merging as in FIG. 6, where n2=n3 (denoted n6). A special case of the merge is the case when both the transitions are reflexive, that is n1=n2=n3. Suppose that T1 was the “correct” match and that b chose T2. At some future time in the execution, b might discover that something is wrong by not being able to interpret and synchronize the interactions with a in a satisfactory way. Several situations could occur:

The receiver could discover the mismatch soon and restore the session successfully. This corresponds to the application graph in FIG. 6, where message m5 is a send event from component b, if the elements in m5 depend on the elements in an earlier message.

The receiver could fail to discover the mismatch and proceed as if it successfully matched the elements. The next event is a message sent to component a, which is independent of the partial matches T1 and T2. The situation is shown in FIG. 6, if elements e3 and e4 in m2 are independent of elements e5 and e6 in m5.

The receiver could fail to discover a mismatch and send an improper message to component a that is erroneously interpreted to be correct. In this case, both components a and b have unhealthy matching tables. This corresponds to FIG. 5, where component b mistakenly interprets the received message M as an m2 instance, and then sends message m4, if component a is in a state such that m4 can match (erroneously) the next transition.

The receiver could fail to discover the mismatch and send an improper message to component a, but component a cannot interpret the reply meaningfully. This is situation is similar to the previous one except that component a cannot match m4 successfully.

Additionally, more complicated error scenarios can be constructed, particularly if both components a and b have non-deterministic matching choices.

A component that discovers an erroneous match can try to perform backtracking in order to correct the session. In practice, this means to reinterpret the recent matchings of actions, and find the branching state where the erroneous match was performed.

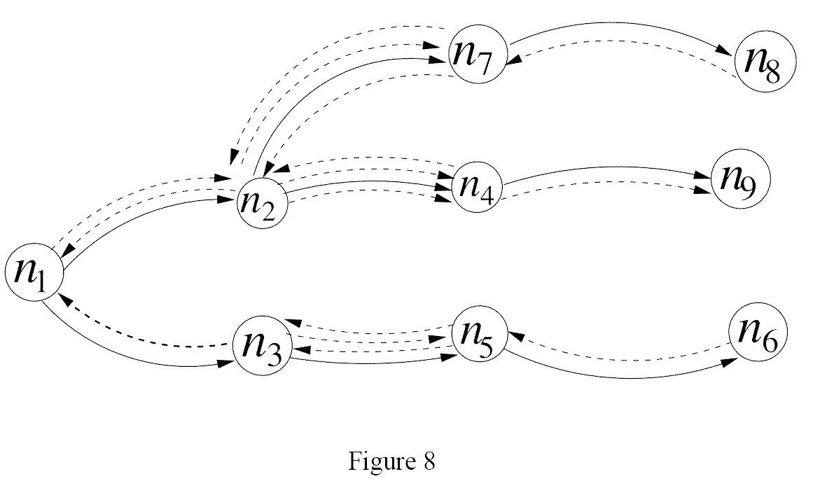

Backtracking has its limitations: Suppose that the host component b has received a command that it interprets as (Lose a), and that it should have interpreted it as a win. The relevant part of the application graph of the host b is depicted in FIG. 8. For convenience, it is assumed that the application graph of the foreign component a is similar, except that all small letters in the constants are replaced by capital letters (that is Win is replaced by WIN). It is further assumed that the names of the nodes are equal in both graphs. In state n5, the host b receives the message
msg BUSTTHISROUND from a to b
   Component b immediately recognizes the received message as a misplaced message at this stage in the application. The host b backtracks and discovers that the mistake must have occurred from the branching state n1, and reinterprets the command received from component a as instead (Win a). This means that the component b incorrectly matches
<WIN, Lose>
   The problem is now that is that component b has already sent the erroneous message
msg GetCard from b to a (†)
   while it should have been sending
msg throwCard b wildcard(Deck) from b to a.
   Additionally, component a has mistakenly given message (†) a meaningful interpretation. Thus, while component b has followed the path (n1, n3, n5, n6), component a interpreted its own and b's behavior as an instance of path (n1, n2, n7, n8), and the intended execution for both agents is (n1, n2, n4, n9). Even though the component b back tracks and reinterprets its own matchings, component a has an incorrect view of the state of component b that can not be resolved within a single component framework.

Instead of repairing a matching table when a potential mismatch is discovered, it is possible to clone the application graph and the matching table for every branch that could potentially cause a mismatch. This approach is computationally expensive, both in time and space, since every branch potentially generates a new clone, and each clone should be updated at every event. An erroneous match in a point in the life-line of a clone is not a reason for eliminating the clone, since the erroneous matching might be the result of a faulty send event by the remote component.

Another more preferable method for correcting errors is interactive backtracking, a protocol for negotiating the appropriate interpretation of the messages. This protocol is known as the meta-matching protocol, since it should monitor and adjust the underlying matching algorithm. The matching protocol is used to send messages between the components to negotiate an agreement regarding the conflict point in the application graphs. The negotiation is based on the current state of the application graphs, the conflicting match and the state of the matching tables.

Returning to the example shown in FIG. 6, component b is in state n5, listening for incoming messages that suit
(M1) msg getCard wildcard(Deck2) from b to a.
   If component b has an appropriate interpretation of the two commands getCard and bustThisRound, this means: <GETCARD, getCard> and <BUSTTHISROUND, bustThisRound> are both contained in table Tb. Accordingly, when receiving the message “msg GetCard from b to a,” component b immediately discovers that something is wrong, and initiates an active session of the matching protocol. Component b first sends a particular matching message to component a:
(M2) msg Conflict(msg BUSTTHISROUND from a to b) from b to a.

Message M2 is received by component a, but neither component a nor component b can determine which component caused the mismatch. Instead, there are three possibilities: component b was in a correct state, but component a previously had chosen a wrong path, accompanied by a faulty matching; component a was in a correct state, but component b had previously chosen a wrong path while interpreting a message; or both component a and component b had previously misinterpreted messages and chosen wrong paths in their respective application graphs. Since there is no global notion of correct matching in the system, the best the components can do is to negotiate for a potential solution to the conflict match.

After component a receives the conflict-notification message, component a observes that it played the active sender role, and realizes that both agents must retract the last message. Accordingly component a sends message
(M3) msg Retract from a to b
   The meaning of this meta-match message is that both the sender and the receiver of the message move their respective current pointer one step back and try another option, if possible. In FIG. 6, component b sets Current_{b}=n5, while component a sets Currentₐ=n7. At state n7, component a did not have any other option than transmitting “msg GetCard from b to a,” and concludes that the agents must retract one further event, and therefore sends another instance of (M3). Component a retracts the transition (n2, n7), and observes that there is another possible interpretation originating in n2, the message
(M4) msg THROWCARD b wildcard(Deck) from b to a
   Component b retracts in a similar way back to node n3, but has no option other than re-sending message (X) again. By following this path, component a receives a conflicting match, and notifies component b of the conflict by sending
(M5) msg Conflict

(msg THROWCARD b wildcard(Deck) from b to a) from a to b. Component b has only one option, to ask for retraction at state n5. The situation now is that the retrieved transition (n1, n2) is the only option for component a based on a's previous events in the game, hence component a sends a retract message to component b. Fortunately component a has another possibility, to interpret the message
(M6) msg WIN a from a to b
   differently than it did initially (i.e., not following transition <n1, n3>), by instead matching the message with transition <n1, n2>.

Component b consequently sends the message
(M7) msg throwCard b wildcard(Deck) from b to a
   that component a attempts to match with the transition <n2, n7>. This gives a conflicting matching for a, and both agents retract to node n2. Following this retraction, component b resends message (M6) and component a interprets the message correctly as being (M4) message over the transition <n2, n4>.

The conflict is resolved when component a sends the message
(M8) msg QUITGAME b from a to b
   that is matched correctly by component b in the transition <n4, n9>. At this point both components have agreed upon a conflict-free state, and are on the same level as the initial conflict. Thus, at this point the application might continue to run an on-the-fly matching using the transitions originating in state n9.

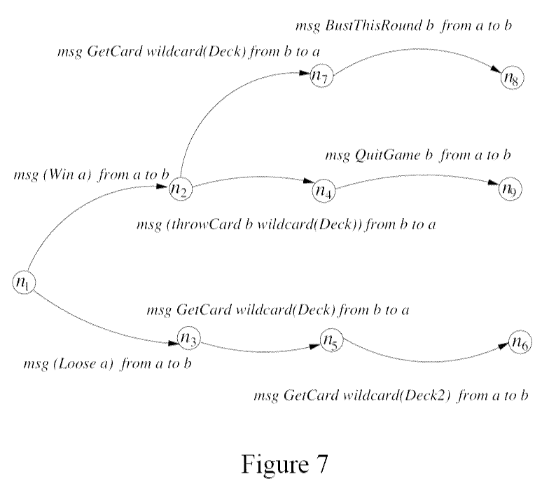

FIG. 8 shows the execution of the interactive Backtracking on the application graphs. At each state where component a has a conflicting match <e1, e2> and <e1, e3>, the two matching pairs are removed from the matching table. Each move backwards <nₜ, nₜ₋₁> in the graph is either ending in a branching or non-branching node. If Current is reset to a non-branching node, then there are two possibilities regarding the transition (nₜ. nₜ₋₁, m): either m is a message sent by a, or it is a message received by a. If component a sent message m, then component a knows that the current transition is not the reason for the mismatch, and sends a retract message to component b. If component a received message m, then b could have made a mismatch earlier, and a waits for a retract message from b.
If Current is reset to a branching node, then a choice element choice(d, Bm)
   is created that contains the distance d to the conflicting node and the branches Bm to be investigated. The initial choice element for n2 in FIG. 7, is
choice(2,{<n2,n7>,<n2,n4>})
   meaning that there are 2 transitions to the conflicting node n8, and there are two possible transitions <n2, n7> and <n2, n4> originating from the branching node n2. The choice-element is used as follows:
The choice-element is used to have a local book-keeping of the branches that can be candidates for potential matches. The first reversed visit at a branching node creates the choice element. Then the reversed transition is deleted from Bm and another remaining transition is chosen. Then the application is run forwards as many steps as d permits.
If the d-length node ends in another conflicting state, the components backtrack to the branching node, remove the current transition and try a path not yet explored.
If the d-length node ends in conflict-free matching state, the choice-element is removed, and the matching proceeds.
If there are no remaining paths to try, then the choice element is removed, and both components retract one transition.
If it is not possible to backtrack further, then the matching failed.

Backtracking over merging transitions could potentially cause a problem since there is presumably a choice of transitions to retract. But this is taken care of since both the sender and receiver knows which transition was chosen in the first place, hence they retract their original transitions performed.

Assuming an application graph that contains no cycles, matching performed on that graph must terminate. Moreover, assuming the graph has B branches and a longest path P, the matching protocol terminates in less than C×B^{P+2}, where C is a constant. Additionally, implicit cycles, reflexive transitions, and small loops cause no additional problems because the choice element keeps track of these in a manner similar to ordinary tree structures. For “simple” application graphs containing one explicit loop, the matching protocol terminates in less than R×C×B^{P+2}, where C is a constant and R is a number of rounds. These equations show that the meta-matching algorithm will always progress and attempt to solve every discovered mismatch. However, it is not possible to detect unintended matches.

While various embodiments of the present invention have been shown and described, it should be understood that other modifications, substitutions, and alternatives may be apparent to one of ordinary skill in the art. Such modifications, substitutions, and alternatives can be made without departing from the spirit and scope of the invention, which should be determined from the appended claims.

Various features of the invention are set forth in the appended claims.

1. A method of matching message elements comprising:
a reading step of reading a first content and a second content;
a determining step of determining whether the first content is the same as the second content, wherein if the first content matches the second content, a new pair is formed that includes the first content and the second content;
a matching table lookup step of reading a matching table, which stores one or more pairs of matching elements;
a consistency check step of determining whether the new pair is consistent with the one or more pairs of matching elements stored in the matching table; and
a storage step of storing the new pair in the matching table based on the result of the consistency check step.

2. The method of matching recited in claim 1, wherein the first content is read from a received message and a second content is read from an application graph.

3. The method of matching recited in claim 2, wherein the new pair is determined to be consistent with the one or more pairs of matching elements stored in the matching table when the new pair is identical to a pair already stored in the matching table.

4. The method of matching recited in claim 2, wherein the new pair is determined to be consistent with the one or more pairs of matching elements stored in the matching table when the second content is a wildcard.

5. The method of matching recited in claim 2, wherein the new pair is determined to be consistent with the one or more pairs of matching elements stored in the matching table when the second content is not a wildcard and is not matched with any other content, and the first content is not matched with a constant.

6. The method of matching recited in claim 1, further comprising an outputting step of outputting an application graph after storing the new pair in the matching table.

7. The method of matching recited in claim 6, wherein the output application graph is provided as input to a visualization tool.

8. The method of matching recited in claim 6, wherein the output application graph is compared with other application graph to determine similarity, and similar application graphs are placed into groups.

9. The method of matching recited in claim 6, wherein the output application graph is stored in a database

10. A method of integrating two or more software components, comprising the steps of:
modeling a first software component as a first finite state machine having a plurality of states, and one or more transitions connecting the plurality of states, wherein each of the one or more transitions is associated with a message;
modeling a second software component as a second finite state machine having a plurality of states and one or more transitions connecting the plurality of states, wherein each of the one or more transitions is associated with a message;
the first software component sending the associated message to the second software component each time a current state of the first software component follows one of the one or more transitions;
the second software component receiving the message sent by the first software component and determining whether the received message matches an expected message; and
the second software component sending the associated message to the first component each time a current state of the second software component follows one of the one or more transitions.

11. The method of integrating as recited in claim 10, wherein if the second software component determines that the received message does not match the expected message, the second software component sends a conflict message to the first component.

12. The method of integrating as recited in claim 11, wherein when the first component receives a conflict message, the first component send a retract message to the second component, indicating that both the first component and the second component should return to their respective previous states.
